(19) United States
(12) Patent Application Publication
(10) Pub. No.: US 2023/0119166 A1
(43) Pub. Date: Apr. 20, 2023

(54) Home Protection Dome Device

(71) Applicant: Timothy Collins, Inman, SC (US)

(72) Inventor: Timothy Collins, Inman, SC (US)

(21) Appl. No.: 17/831,073

(22) Filed: Jun. 2, 2022

Related U.S. Application Data
(60) Provisional application No. 63/256,779, filed on Oct. 18, 2021.

(51) Int. Cl. E04B 1/344; E04B 1/32; E04H 9/14; H02S 40/38

(52) U.S. Cl. CPC E04B 1/3448; E04B 1/3211; E04H 9/14; H02S 40/38; E04B 2001/327

(57) ABSTRACT

The present invention relates generally to the field of home protection devices. More specifically, the present invention relates to a home protection dome device primarily comprised of at least one motor that powers a dome structure. The dome structure is comprised of a plurality of curved members that enclose and shield a home, other structure or object. The curved members can be deployed and retracted via a track within a base, wherein the track is powered by a motor. The motor may further receive power from a solar panel. The motor may also be controlled by a control panel to move the track and deploy or retract the curved members over a home, structure, or object in an enclosed manner. In this manner, the home, structure, or object is protected from severe weather.

### CROSS-REFERENCE TO RELATED APPLICATION

The present application claims priority to, and the benefit of, U.S. Provisional Application No. 63/256,779, which was filed on Oct. 18, 2021, and is incorporated herein by reference in its entirety.

### FIELD OF THE INVENTION

The present invention relates generally to the field of home protection devices. More specifically, the present invention relates to a home protection dome device primarily comprised of at least one motor that powers a dome structure. The dome structure is comprised of a plurality of curved members that enclose and shield a home or other structure or object. The curved members can be deployed and retracted via a track within a base, wherein the track is powered by a motor. The motor may further receive power from a solar panel. The motor may also be controlled by a control panel to move the track and deploy or retract the curved members over a home, structure, or object in an enclosed manner. In this manner, the home, structure, or object is protected from severe weather. Accordingly, the present disclosure makes specific reference thereto. Nonetheless, it is to be appreciated that aspects of the present invention are also equally applicable to other like applications, devices and methods of manufacture.

### BACKGROUND

Structures such as homes, garages, and various other buildings may be highly susceptible to serious damage during environmental disasters, such as forest fires, floods, hurricanes, tornadoes, etc. During said weather events, homeowners may try to protect their homes and/or structures with various attachments and maintenance. However, said attachments and maintenance require physical effort and are often ineffective in protecting homes and structures from severe weather.

Therefore, there exists a long-felt need in the art for a device that protects a home, structure, or other object located outdoors. There also exists a long-felt need in the art for a home protection dome device that protects a home, structure, or other object from inclement weather. Further, there exists a long-felt need in the art for a home protection dome device that protects a home, structure, or other object from inclement weather that does not require physical exertion to operate.

The subject matter disclosed and claimed herein, in one embodiment thereof, comprises a home protection dome device. The device is primarily comprised of at least one motor that powers a dome structure. The device is intended to be used to protect buildings, structures, objects, etc., from inclement weather conditions such as, but not limited to: floods, hurricanes, tornadoes, etc. The dome structure is comprised of a plurality of curved members that enclose and shield a home or other structure or object. The curved members can be deployed and retracted via a track within a base, wherein the track is powered by a motor. The motor may further receive power from a solar panel. The motor may also be controlled by a control panel to move the track and deploy or retract the curved members over a home, structure, or object in an enclosed manner.

In this manner, the home protection dome device of the present invention accomplishes all of the foregoing objectives and provides a device that protects a home, structure, or other object located outdoors. The device further protects a home, structure, or other object from inclement weather. While doing so, the device also does not require physical exertion to operate.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a home protection dome device. The device is primarily comprised of at least one motor that powers a dome structure. The device is intended to be used to protect buildings, structures, objects, etc., from inclement weather conditions such as, but not limited to: floods, hurricanes, tornadoes, etc. In one embodiment, the device is comprised of a dome structure that encloses a structure and thereby shields the structure from weather damage. The dome structure is comprised of at least one curved member that is preferably made from a metal material such as, but not limited to: stainless steel or aluminum. The material of the curved member, and more specifically the outer surface of the curved member, is preferably waterproof and fire-resistant.

The dome structure preferably has a plurality of curved members connected to one another to form the overall dome structure and dome-like shape, wherein each member may be connected to one another via at least one hinge or other connection mechanism that allows the members to fold and collapse in a stored position when the device is not in use.

The device is further comprised of a base located on each end of the curved member, wherein the ends of each curved member attach to the base. More specially, the ends of each curved member attach to a movable track within the base that receives power from the at least one motor.

The motor receives power from at least one battery. The battery may further receive power from at least one solar panel that is in electrical communication with the battery via wiring. In order to activate the motor to move the track and retract or deploy the curved members over a house, the device is also comprised of at least one control panel that may be located on or near the motor and/or at a secondary location, such as within a house. The control panel may be in wireless or hardwired (via wiring) electrical communication with the motor such that at least one button on the control panel can be used to turn the motor on/off and/or to retract or deploy the dome structure.

Accordingly, the home protection dome device of the present invention is particularly advantageous as it provides a device that protects a home, structure, or other object located outdoors. The device further protects a home, structure, or other object from inclement weather. While doing so, the device also does not require physical exertion to operate. In this manner, the home protection dome device provides a novel solution to protect homes, structures, and objects from severe weather.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a home protection dome device of the present invention deployed around a home in accordance with the disclosed architecture; and

FIG. 2 illustrates a side view of one potential embodiment of a home protection dome device of the present invention while retracted around a home in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that protects a home, structure, or other object located outdoors. There also exists a long-felt need in the art for a home protection dome device that protects a home, structure, or other object from inclement weather. Further, there exists a long-felt need in the art for a home protection dome device that protects a home, structure, or other object from inclement weather that does not require physical exertion to operate.

The present invention, in one exemplary embodiment, is comprised of a home protection dome device primarily comprised of at least one motor that powers a dome structure. The device is intended to be used to protect buildings, structures, objects, etc., from inclement weather conditions such as, but not limited to: floods, hurricanes, tornadoes, etc. The device may be comprised of a dome structure that encloses an outdoor structure or object and thereby shields the structure or object from weather damage. The dome structure is comprised of at least one curved member that is preferably made from a metal material such as, but not limited to: stainless steel or aluminum. The material of the curved member, and more specifically the outer surface of the curved member, is preferably waterproof and fire-resistant.

Furthermore, the dome structure preferably has a plurality of curved members connected to one another to form the overall dome structure and dome-like shape, wherein each member may be connected to one another via at least one hinge or other connection mechanism that allows the members to fold and collapse in a stored position when the device is not in use.

The device is further comprised of a base located on each end of the curved member, wherein the ends of each curved member attach to the base. More specially, the ends of each curved member attach to a movable track within the base that receives power from the at least one motor.

The motor receives power from at least one battery. The battery may further receive power from at least one solar panel that is in electrical communication with the battery via wiring. To activate the motor to move the track within the base and retract or deploy the curved members over a house, the device is also comprised of at least one control panel that may be located on or near the motor and/or at a secondary location, such as within a house. The control panel may be in wireless or hardwired (via wiring) electrical communication with the motor such that at least one button on the control panel can be used to turn the motor on/off and/or to retract or deploy the dome structure.

Accordingly, the home protection dome device of the present invention is particularly advantageous as it provides a device that protects a home, structure, or other object located outdoors. The device further protects a home, structure, or other object from inclement weather. While doing so, the device also does not require physical exertion to operate. In this manner, the home protection dome device provides a novel solution to protect homes, structures, and objects from severe weather.

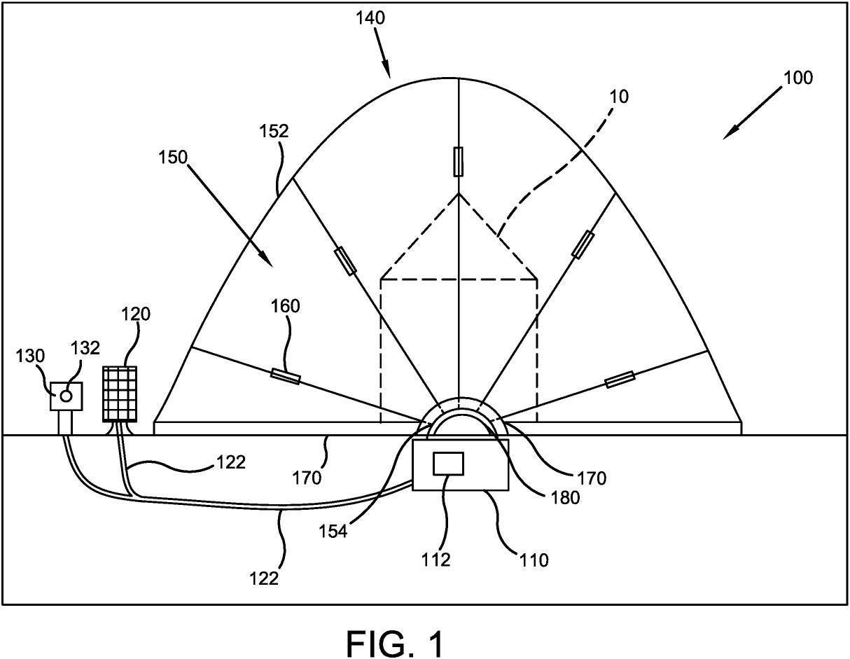

Referring initially to the drawings, FIG. 1 illustrates a side view of one potential embodiment of a home protection dome device 100 of the present invention deployed around a home 100 in accordance with the disclosed architecture. The device 100 is primarily comprised of at least one motor 110 that powers a dome structure 140. The device 100 is intended to be used to protect buildings, structures, objects, etc., from inclement weather conditions such as, but not limited to: floods, hurricanes, tornadoes, etc. In this manner, the device 100 may be any size and shape in order to adequately protect and cover said buildings, structures, objects, etc., of any size as needed.

In the illustrated embodiment, the device 100 is being used to protect a home 10. The device 100 is comprised of a dome structure 140 that encloses the home 10 and thereby shields the home from weather damage. The dome structure 140 is comprised of at least one curved member 150. The dome structure 140 is preferably dome-like in shape but may be other shapes in differing embodiments. In one embodiment, the curved member 150 is made from a metal material such as, but not limited to, stainless steel or aluminum. The material of the curved member 150, and more specifically the outer surface 152 of the curved member 150, is preferably waterproof and fire-resistant.

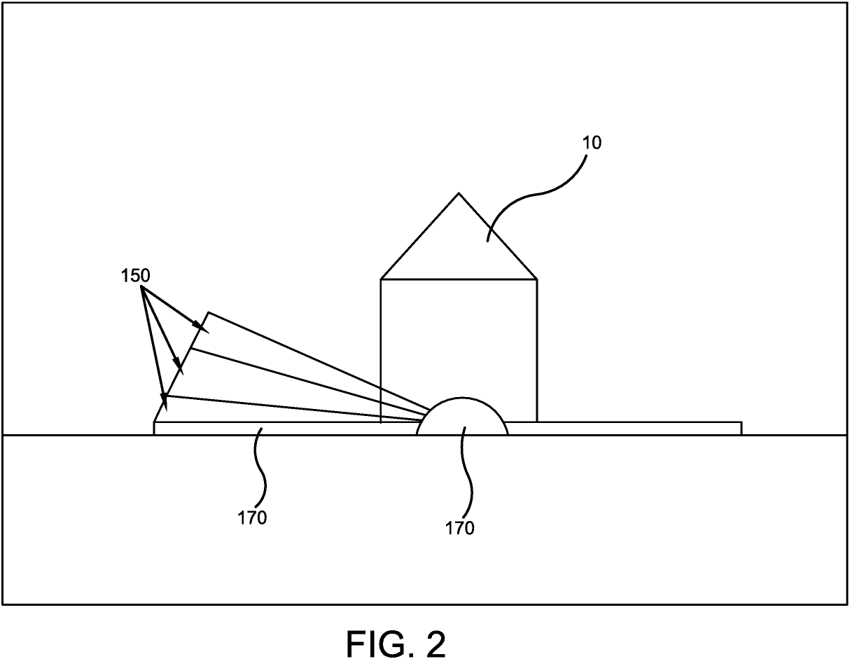

The dome structure 140 preferably has a plurality of curved members 150 connected to one another to form the overall dome structure 140 and dome-like shape. Each member 150 may be connected to one another via at least one hinge 160 or other connection mechanism that allows the members 150 to fold and collapse in a stored position (as seen in FIG. 2) when the device 100 is not in use. The hinge 160 is preferably water-tight between each member 150 when in the deployed position.

The device 100 is further comprised of a base 170 located on each end 154 of the curved member 150. The ends 154 of each curved member 150 attach to the base 170. More specially, the ends 154 of each curved member 150 attach to a movable track 180 within the base 170. The track 180 receives power from the at least one motor 110 that can be used to move the track 180 within the base 170.

In various embodiments, the motor 110 may be located above or below ground. The motor 110 receives power from at least one battery 112. The battery 112 may be a disposable battery 112 or a rechargeable battery 112 in the form of an alkaline, nickel-cadmium, nickel-metal hydride battery 112, etc., such as any 3 V-12 volts DC battery 112 or other conventional battery 112 such as A, AA, AAA, etc., that supply power to the device 100. Throughout this specification the terms “battery” and “batteries” may be used interchangeably to refer to one or more wet or dry cells or batteries 112 of cells in which chemical energy is converted into electricity and used as a source of DC power. References to recharging or replacing batteries 112 may refer to recharging or replacing individual cells, individual batteries 112 of cells, or a package of multiple battery cells as is appropriate for any given battery 112 technology that may be used. The battery 112 may further receive power from at least one solar panel 120 that is in electrical communication with the battery 112 via wiring 122. In differing embodiments of the device 100, the solar panel 1120 may be comprised of, but not limited to: monocrystalline silicon, polycrystalline silicon, or a photovoltaic cell film.

In order to activate the motor 110 to move the track 180 and thereby retract or deploy the curved members 150 over a house, the device 100 is also comprised of at least one control panel 130. The control panel 130 may be located on or near the motor 110 and/or at a secondary location, such as within a house 10. The control panel 130 is in wireless or hardwired (via wiring 122) electrical communication with the motor 110 such that at least one button 132 on the control panel 130 can be used to turn the motor on/off and/or to retract or deploy the dome structure 140.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “home protection dome device” and “device” are interchangeable and refer to the home protection dome device 100 of the present invention.

Notwithstanding the foregoing, the home protection dome device 100 of the present invention and its various components can be of any suitable size and configuration as is known in the art without affecting the overall concept of the invention, provided that they accomplish the above-stated objectives. One of ordinary skill in the art will appreciate that the size, configuration and material of the home protection dome device 100 as shown in the FIGS. are for illustrative purposes only, and that many other sizes and shapes of the home protection dome device 100 are well within the scope of the present disclosure. Although the dimensions of the home protection dome device 100 are important design parameters for user convenience, the home protection dome device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A home protection dome device comprising:
a motor;
a dome structure comprised of a curved member;
a base comprised of a track; and
a control panel.

2. The home protection dome device of claim 1, wherein the track is powered by the motor.

3. The home protection dome device of claim 2, wherein the curved member is attached to the track.

4. The home protection dome device of claim 1, wherein the control panel controls the motor.

5. The home protection dome device of claim 4, wherein the dome structure is repositionable between a deployed configuration and a deployed configuration.

6. A home protection dome device comprising:
a motor;
a battery;
a dome structure comprised of a curved member;
a base comprised of a track, wherein the track receives the curved member; and
a control panel having a button.

7. The home protection dome device of claim 6, wherein the curved member is comprised of a waterproof material.

8. The home protection dome device of claim 6, wherein the curved member is comprised of a water-resistant material.

9. The home protection dome device of claim 8, wherein the control panel is in electrical communication with the motor.

10. A home protection dome device comprising:
a motor;
a battery;
a dome structure comprised of a first curved member and a second curved member;
a hinge;
a base comprised of a track, wherein the track receives an end of the curved member;
a solar panel; and
a control panel comprised of an actuator.

11. The home protection dome device of claim 10, wherein the second curved member attaches to the first curved member.

12. The home protection dome device of claim 11, wherein the second curved member attaches to the first curved member via the hinge.

13. The home protection dome device of claim 12, wherein the hinge is water tight.

14. The home protection dome device of claim 10, wherein the second curved member and the first curved member are collapsible into a stored position.

15. The home protection dome device of claim 10, wherein the motor receives a power from the battery.

16. The home protection dome device of claim 15, wherein the battery receives a power from the solar panel.

17. The home protection dome device of claim 10, wherein the motor powers the track.

18. The home protection dome device of claim 17, wherein the motor repositions the track.

19. The home protection dome device of claim 18, wherein moving the track retracts and deploys the curved members attached to the track.

20. The home protection dome device of claim 10, wherein the solar panel is comprised of a monocrystalline silicon, a polycrystalline silicon or a photovoltaic cell film.
